(19) United States
(12) Patent Application Publication
(10) Pub. No.: US 2019/0134964 A1
(43) Pub. Date: May 9, 2019

(54) No-Bake Centre Label for Use in Vinyl Record Manufacturing

(71) Applicant: 1508235 ONTARIO INC., Toronto (CA)

(72) Inventors: Noble MUSA, Brampton (CA); Frank STIPO, North York (CA)

(73) Assignee: 1508235 ONTARIO INC.

(21) Appl. No.: 15/804,347

(22) Filed: Nov. 6, 2017

(51) Int. Cl. B32B 27/30; B32B 27/08; B32B 37/10; G09F 3/02

(52) U.S. Cl. CPC B32B 27/304; B32B 27/08; B32B 37/10; B32B 2307/516; B32B 2519/00; B32B 2307/304; B32B 2307/518; G09F 3/02

(57) ABSTRACT

A no-bake label for use in heat fusible applications including compression moulding of plastic products, and particularly PVC record manufacturing, is provided. The label may include a laminate paper backing layer composed of a polymeric film interposed and bonded between first and second paper web layers; a primer layer in juxtaposed contact with a forward facing side of the backing layer corresponding to a side of the first paper web layer; and printed indicia overlaying at least part of the primer layer. The no-bake label may advantageously be made of material that is starch-free and that resists the accumulation of humidity or moisture; and include a protective layer that has a thickness and thermal resistivity and/or reflectivity which assist in preventing bubbling of the printed indicia layer or the first paper web layer at a contact temperature of between 100° C. and 300° C. for between 2 and 60 seconds.

### SCOPE OF THE INVENTION

The present invention relates to labels for hot moulding applications, preferably to labels for use in hot moulding of plastic or polyvinyl chloride (PVC) products, and in a most preferred aspect, to a no-bake centre label for use in PVC record manufacturing.

### BACKGROUND OF THE INVENTION

PVC records are traditionally manufactured by heating and pressing PVC material between a pair of metal plates that have been pre-molded to contain grooves, which represent music information. In order to better identify the resulting record, paper labels (inscribed with artist and song identifiers) are regularly included in the pressing process with the PVC material. As the PVC is flattened and imprinted with music information, the labels are thermally fused to either sides of the resulting record.

In order to prevent the paper labels from sticking to the metal plates during the pressing process, the paper stock used in the PVC press is commonly pre-heated or “pre-baked” in an oven, as a separate manufacturing step, as for example, to temperatures of between about 50 and 200 degrees C., preferably about 160 degrees C., for between about 30 minutes and 12 hours. This “pre-baking” process is designed to eliminate any moisture or humidity that may have accumulated in the paper labels prior to the pressing process. If the labels are not sufficiently pre-heated or “baked” prior to being pressed, or if they are allowed to cool for too long a time before pressing, the labels may cling or “stick” to the metal plates during the pressing process, which ultimately may result in unwanted peeling of the labels from the resulting records and/or in tearing of the labels upon opening. In an ideal scenario, a traditional label bound for a PVC press should be substantially dry or free of water in order to avoid the sticking of the label to the metal plates during the high heat pressure operation (i.e. contain less than 5%, preferably less than about 2%, and most preferably less than 1% water/moisture).

At times, labels that are not sufficiently pre-heated or pre-baked may also experience the loss of ink(s) by way of adherence to the metal plates (i.e. “ink lift”) during the pressing process, thereby rendering the resulting records unsellable. This “ink lift” effect is most often seen in pressing operations that use water-based inks to print labels. Water-based inks introduce another source of humidity or moisture to the labels during printing, which (as described above) could lead to unwanted sticking of the labels to the metal plates and/or to “ink lift”.

Current PVC record labels are also prone to yellowing or “browning” during the aforementioned “baking” process. This “browning” or unfavourable discolouring of the labels is at least partly due to the oxidation of organic compounds within the paper, which is accelerated in the presence of high temperatures, such as those experienced in the pre-baking of typical labels for the record manufacturing process. Pre-baking times and temperatures generally depend upon the type of paper which is used and on the level of ink content in the label. Typically, a small capacity laboratory grade gravity convection oven with forced air is used for this application. Traditional labels used in the record manufacturing industry require pre-baking to temperatures of between about 50 and 200 degrees C., preferably about 160 degrees C., for between about 30 minutes to up to 12 hours in one of these ovens. During pre-baking, labels are generally suspended within the oven by a spindle (with shelves removed) in a skewer-like arrangement. A “browning” of the labels may occur whenever the paper label is baked for longer periods of time. Paper labels that are not acid-free and/or that contain high levels of starch (a known water retention aid) are particularly prone to “browning” in PVC record manufacturing. The paper stock used in such labels is more likely to experience degradation by way of acid hydrolysis, which essentially breaks down the cellulose contained in the paper into carbon compounds that are more readily oxidized during the pre-baking process.

It is estimated that between 10 and 15% of PVC records manufactured in PVC record presses using traditional “pre-bake” labels are lost due to issues related to damaged labels.

### SUMMARY OF THE INVENTION

The Inventor has recognized the inherent problems and lack in the art and observed that there is a need for an improved label to be used in heat fusible applications which may include, for example, compression moulding of plastic containers, toys, automobile parts, protective shields/coverings, and mats. In a preferred aspect, the improved label is produced as a substantially moisture-free “no-bake” label which may be particularly suited to PVC record manufacturing, and which does not require separate “pre-baking”, or for example, pre-heating to temperatures in excess of 50 degrees C. up to 200 degrees C., 160 degrees C. on average, to effect the elimination or reduction of moisture, prior to being fused to a plastic or PVC substrate in a press.

A no-bake label according to one aspect of the present invention is preferably substantially waterless and is characterized by a moisture content of less than 5%, preferably less than about 2%, and most preferably less than about 1%. The label may advantageously be made of material layers that each resist the accumulation of humidity or moisture, thereby reducing or eliminating the need to pre-bake the labels, and hence reducing problems associated with the “browning”, charring or scorching of the labels during pre-baking operations.

By providing materials and process conditions which avoid the unnecessary accumulation of water or humidity within the label, problems associated with clinging or sticking of the label to the metal plates of the PVC press may also be avoided. In one non-limiting aspect, the no-bake label may include one or more substantially starch-free paper web layers.

In one possible embodiment, the applicant has envisioned the label as including a top-most or upper protective layer that has a thickness as well as thermal properties, which assists in preventing the “bubbling” or wrinkling of the no-bake label (including the “bubbling” or disturbance or “lifting” of any ink(s) located in or on the surface of the label) during high heat pressing operations of between about 100 and 300 degrees C., more preferably between about 120 and 150 degrees C., for periods of between about 2 and 60 seconds, more preferably between about 10 and 20 seconds.

The applicant has also envisioned, in a non-limiting embodiment, the label as including a laminate paper backing layer having a polymeric film bonded to at least one paper web layer. Suitable backing layers are preferably produced by solvent-free lamination processes, and which incorporate one or more sheets of paper web and preferably a polymeric film as for example are sold by Mohawk Fine Paper Inc. under the product name PaperTyger®. United States Patent Applications Publication Nos. US 2009/0096703 A1, US 2016/0052240 A1 and US 2016/0057901 A1, each of which are incorporated herein in their entireties, disclose exemplary laminate paper backing layers that may be used in the present invention. Most preferably, each of the individual layers of the laminate paper baking layer are themselves selected to be substantially waterless with a water/moisture content of less than 5%, preferably less than about 2%, and most preferably less than about 1% by weight.

In a non-limiting application, it is envisioned that the no-bake label of the present invention may furthermore be used as a centre label as part of a PVC record, and assist in improving yield of PVC record presses, as well as in reducing overall PVC record manufacturing costs. In particular, by eliminating the step of pre-baking the label, a non-pre-heat treated label of the present invention may advantageously eliminate an entire heating production step in the vinyl record manufacturing process, and thus eliminate the problem of “browning” typically experienced during “pre-baking” of record labels. In this way, the no-bake label of the present invention may also increase efficiency and reduce manufacturing costs and manufacturing times.

In another non-limiting aspect of the invention, there is provided a heat bondable label for thermal fusing with a plastic substrate, the label including: a substantially waterless laminate paper backing layer having first and second paper web layers, and a polymeric film interposed and bonded between the first and second paper web layers, each paper web layer selected from the group consisting of softwood kraft papers, hardwood kraft papers, recycled fiber papers, synthetic papers, cotton papers, linen papers and cotton and linen fiber blended papers, the laminate paper backing layer having a forward and rearward facing side, the forward facing side corresponding to a side of the first paper web layer; a primer layer in juxtaposed contact with the forward facing side, the primer layer including a UV curable catalyst; and a substantially waterless printed indicia layer disposed over at least a portion of the primer layer.

In yet another non-limiting aspect of the invention, there is provided a heat bondable label for thermal fusing with a plastic substrate, the label including: a substantially waterless laminate paper backing layer having a paper web layer and a polymeric film bonded to the paper web layer, the paper web layer selected from the group consisting of softwood kraft papers, hardwood kraft papers, recycled fiber papers, synthetic papers, cotton papers, linen papers and cotton and linen fiber blended papers, the laminate paper backing layer having a forward and rearward facing side, the forward facing side corresponding to a side of the paper web layer; a primer layer in juxtaposed contact with the forward facing side, the primer layer including a UV curable catalyst; and a waterless ink or substantially waterless printed indicia layer disposed over at least a portion of the primer layer.

In a further non-limiting aspect of the invention, the heat bondable label may further include a UV thermally insulated protective coating covering the printed indicia layer and the primer layer, wherein the protective coating has a thickness and thermal resistivity and/or reflectivity selected to maintain the printed indicia layer and the first paper web layer below a contact bubbling temperature of between 100° C. and 300° C., and preferably between 120° C. and 150° C., for between 2 and 60 seconds, preferably 10 and 20 seconds.

In a further non-limiting aspect of the invention, there is provided a heat bonded label in combination with a polyvinyl chloride record, wherein the label includes: a substantially waterless laminate paper backing layer having first and second paper web layers, and a polymeric film interposed and bonded between the first and second paper web layers, each paper web layer selected from the group consisting of softwood kraft papers, hardwood kraft papers, recycled fiber papers, synthetic papers, cotton papers, linen papers and cotton and linen fiber blended papers, the laminate paper backing layer having a forward and rearward facing side, the forward facing side corresponding to a side of the first paper web layer; a primer layer in juxtaposed contact with the forward facing side, the primer layer including a UV curable catalyst; a printed indicia layer disposed over at least a portion of the primer layer; and a UV thermally insulated protective coating covering the printed indicia layer and the primer layer, wherein the protective coating has a thickness and thermal resistivity and/or reflectivity selected to maintain the printed indicia layer and the first paper web layer below a contact bubbling temperature of between 100° C. and 300° C., and preferably between 120° C. and 150° C., for between 2 and 60 seconds, preferably 10 and 20 seconds.

In yet another non-limiting aspect of the invention, the polymeric film of the heat bondable or bonded label may have a thermal resistivity selected to maintain dimensional stability and prevent shrinkage and distortion of the polymeric film at temperatures of between 100° C. and 300° C., and preferably between 120° C. and 150° C., for between 2 and 60 seconds, preferably 10 and 20 seconds.

In a further non-limiting aspect of the invention, the first and second paper web layers of the heat bondable or bonded label may have a thermal resistivity selected to maintain dimensional stability of the first and second paper web layers at temperatures of between 100° C. and 300° C., and preferably between 120° C. and 150° C., for between 2 and 60 seconds, preferably 10 and 20 seconds.

In a further non-limiting aspect of the invention, the polymeric film of the heat bondable or bonded label may include a biodegradable polymer selected from the group consisting of polyethylene, high density polyethylene, low density polyethylene, polyester, polyethylene terephthalate, monoaxially oriented polypropylene and biaxially oriented polypropylene.

In a further non-limiting aspect of the invention, the first and second paper web layers, or alternatively the paper web layer, of the heat bondable or bonded layer may be substantially starch-free.

In yet another non-limiting aspect of the invention, the heat bondable or bonded label is a no-bake center disk record label which is provided without a pre-heating treatment for moisture removal.

In another non-limiting aspect of the invention, there is provided a record having fused thereto a heat bondable label according to the present invention, and wherein the heat bondable label is not subjected to a pre-baking treatment for moisture removal.

In yet another non-limiting aspect of the invention, there is provided a method of fusing at least one heat bondable label according to the present invention to a plastic substrate, including the steps of: placing the at least one bondable label, together with the plastic substrate, in a press having a pair of metal stampers or moulds; and pressing the at least one bondable label and the plastic substrate between the stampers or moulds at a temperature in the range of 100° C. and 200° C., preferably in the range of 120° C. and 150° C., and at a pressure in the range of 100 to 200 tons, preferably about 150 tons, for a period of between 2 and 60 seconds, preferably between 10 and 20 seconds.

In another non-limiting aspect of the invention, the plastic substrate used in the method may include polyvinyl chloride, or may be a polyvinyl chloride puck.

In a further non-limiting aspect of the invention, the metal stampers or moulds used in the method may include grooves that represent audio or music information for imprinting into the plastic substrate.

In yet another non-limiting aspect of the invention, each of the steps in the aforementioned method may be substantially waterless.

Furthermore, the described features and advantages of the disclosure may be combined in various manners and embodiments as one skilled in the relevant art will recognize. The disclosure can be practised with or without one or more features and advantages in a particular embodiment.

Further advantages of the present disclosure will become apparent from a consideration of the drawings and ensuing description.

### BRIEF DESCRIPTION OF THE DRAWINGS

The advantages and features of the present disclosure will become understood with reference to the following more detailed description and claims taken in conjunction with the accompanying drawings, and in which:

FIG. 1 provides an enlarged perspective view of a no-bake label for use in vinyl record manufacturing in accordance with a preferred embodiment of the invention;

FIG. 2 provides a partially exploded perspective view of the no-bake label shown in FIG. 1;

FIG. 3 illustrates a partially cut-away perspective view of the no-bake label shown in FIG. 1;

FIG. 4 illustrates schematically the initial positioning of the no-bake label of FIG. 1 in the press moulding manufacture of a PVC record;

FIG. 5 illustrates schematically the press moulding of a PVC record using the press mould of FIG. 4 in operation, with stampers closed; and

FIG. 6 illustrates schematically the no-bake label of FIG. 1, fused into a PVC record using the press mould of FIG. 4.

### DETAILED DESCRIPTION OF THE PREFERRED EMBODIMENT

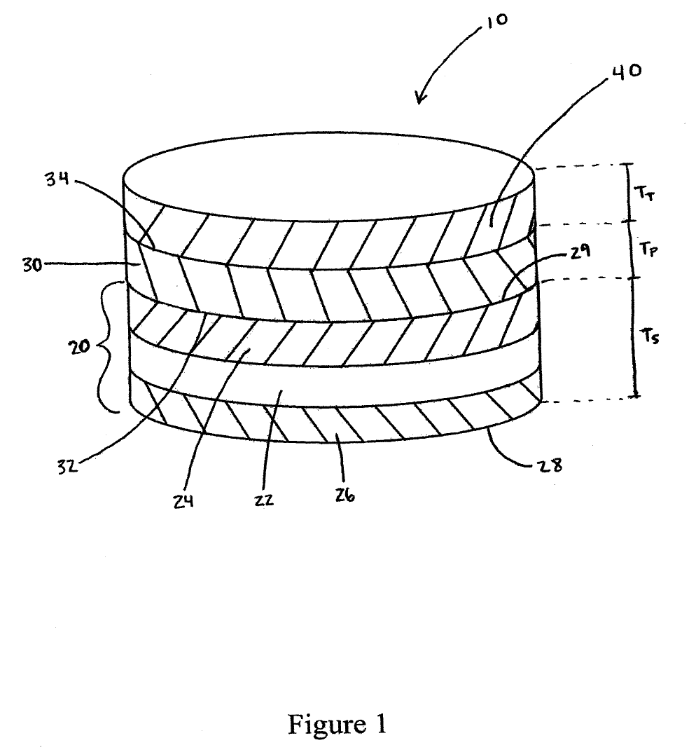

Reference may now be had to FIG. 1, which depicts a preferred embodiment of a substantially waterless no-bake label 10 which, as will be described is adapted for use in PVC or vinyl record manufacturing without requiring pre-heating or pre-baking to effect moisture removal prior to record pressing. It should be noted that, for ease of illustration, various dimensions shown in FIGS. 1 to 3 have been inflated or exaggerated, and thus do not reflect actual proportions of the no-bake label 10.

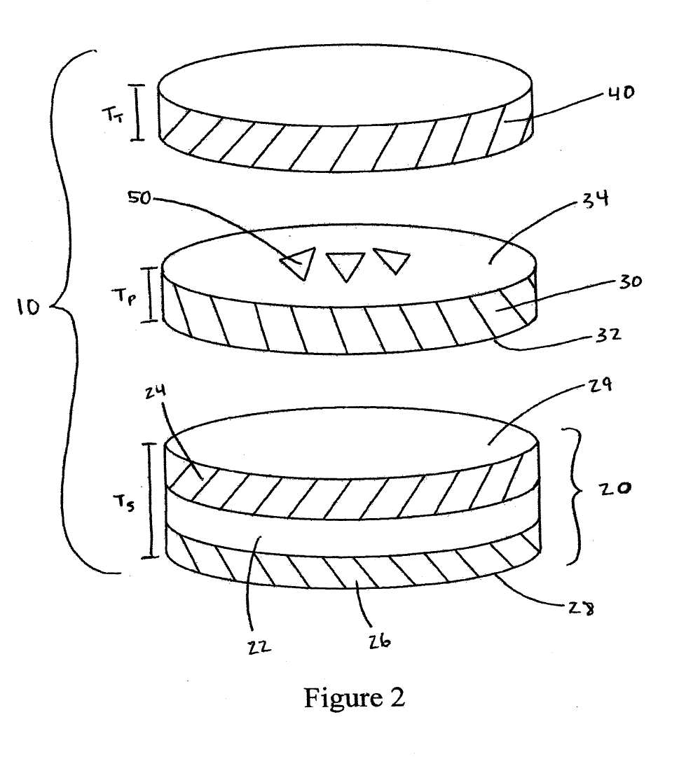

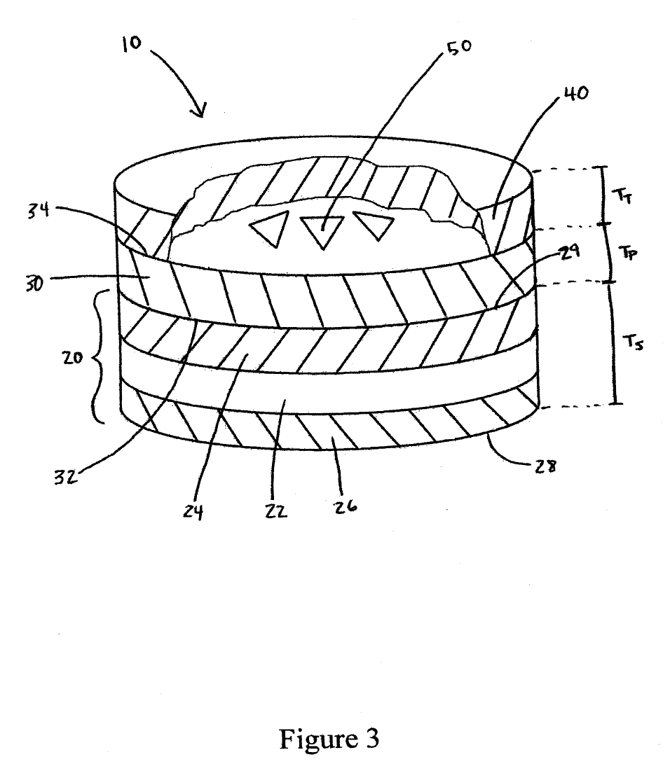

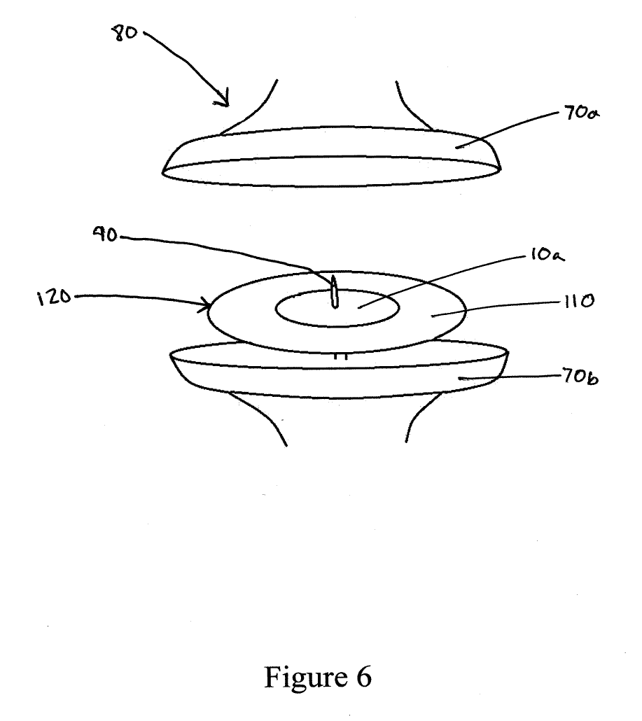

The no-bake label 10 generally includes as separate layers, a laminate paper substrate or backing layer 20 for heat fusing to a plastic or PVC/vinyl record or substrate (shown as 110 in FIG. 6), a bonding agent or primer layer 30, a printed indicia layer 50 (as depicted in FIGS. 2 and 3), and a topcoat or protective coating layer 40.

The backing layer 20 is generally a paper/film plastic laminate. Although not shown to scale, FIG. 1 depicts the backing layer 20 as being composed of a polymeric film 22 sandwiched in between two layers or sheets of paper web 24, 26, in a paper-film-paper configuration.

The two sheets of paper web 24, 26 are preferably made from softwood kraft, hardwood kraft and/or recycled fiber. Other factors that may be considered in selecting the sheets of paper web 24, 26 are brightness, opacity, pH, water resistance, acid content and/or colour. Generally, a GE brightness of about 83 or more (per TAPPI test method T 452) is preferred for printing, preferably about 92 or more. Similarly, an opacity of at least about 77% or more is preferred, while not a requirement.

To achieve high levels of water and humidity resistance, a conventional internal sizing additive and/or a conventional wet strength additive may be included in the sheets of paper web 24, 26. It is also preferable that the sheets of paper web 24, 26 be starch-free and/or acid-free. The colour of the sheets of paper web 24, 26 will depend upon the application, and in particular, upon the chosen aesthetic design for the final label 10.

The polymeric film 22 adds a layer of protection to the backing layer 20, making it tear resistant, grease resistant, and adding to its water resistivity. The polymeric film 22 is generally composed of a biodegradable polymer such as polyethylene, high density polyethylene, low density polyethylene, polyester, polyethylene terephthalate, monoaxially oriented polypropylene, biaxially oriented polypropylene, amongst other materials. The polymeric film 22 may, for example, include a polyactide such as a polyactic acid polymer (PLA) that is biodegradable; or a biodegradable polyolefin such as polyethylene (PE) or polypropylene (PP); or a biodegradable polyester, such as a polyolefin or polyester that includes a biodegradation additive.

In particular, the tear-resistance of the polymeric film 22 adds to the structural strength of the backing layer 20, in that, even in situations where the no-bake label 10 were to “stick” to the metal plates of a PVC press during high heat pressing operations, the no-bake label 10 may be prevented from tearing or ripping. In such a situation, the no-bake label 10 may peel from the plastic or PVC substrate 110, but remain undamaged. As a result, an operator may choose to remove the label 10 from the metal plates and store it for future use (or re-use).

Both the sheets of paper web 24, 26 and the polymeric film 22 have suitable thermal characteristics, which allow them to maintain dimensional stability in the high heat conditions of the PVC record making process. In particular, the sheets of paper web 24, 26 and the polymeric film 22 are selected to withstand temperatures exceeding 100 degrees C., and in particular temperatures in the range of about 100 to 300 degrees C., preferably about 120 to 150 degrees C., for up to 60 seconds, preferably up to 20 or 15 seconds. The polymeric film 22, in particular, further possesses a thermal resistivity selected to resist shrinkage or distortion of the film in the aforementioned temperature ranges. A suitable polymeric film 22 may, for example, consist of a biodegradable polyester with a mechanical strength exceeding about 29,000 psi (approximately 20.4 Kg/mm²) in all directions measured using ASTM D 882, and experiencing thermal shrinkage of less than about 2% using SKC Method (internal measurement of SKC, Inc. of Covington, Ga.), at 150 degrees C. for 30 minutes.

The sheets of paper web 24, 26 and the polymeric film 22 are laminated and adhered to one another via a 100% solids, or solventless or “solvent-free”, adhesive. The resulting backing layer 20 preferably has a thickness T_{S} of between about 0.10 and 0.15 mm, which is akin to that of 27 lb-weight paper (equivalent to a surface density of about 100 g/m²).

In a most preferred embodiment of the invention, each of the sheets of paper web 24, 26 and the polymeric film 22 layers of the backing layer 20 are substantially waterless, having a water, humidity and moisture content of less than about 5%, preferably less than about 2%, more preferably less than about 1% wt. Providing the backing layer 20 as substantially water-free assists in preventing the adherence or sticking of the no-bake label 10 to the metal plates in the high heat pressing operations of a PVC record press. The substantially waterless condition of the backing layer 20 may at least be attributed to the individual water resistive properties of the polymeric film 22 and the sheets of paper web 24, 26 (which were discussed above). Further, prior to use, it is most preferable to minimize any unwanted accumulation of humidity or moisture in the label 10. In one non-limiting application, where the label 10 is not to be used for some period of time, preferably the label 10 is stored in a climate controlled room or space having a humidity level of about 35% or less, preferably about 30% or less.

FIG. 1 further depicts the backing layer 20 as including two sides: a first or rearward facing side 28, and a second or forward facing side 29. The first side 28 is defined as a surface of the sheet of paper web 26 and ultimately consists of the backside of the no-bake label 10, which is to be placed in direct contact with the PVC material during the record making process. The second side 29 is defined as a surface of the sheet of paper web 24 and is provided for direct juxtaposed contact with the layer of bonding agent or primer 30.

For added heat protection, it should be noted that the surfaces of the sheets of paper web 24, 26 that are not in contact with the polymeric film 22 (i.e. the first and second sides 28, 29 of the backing layer 20) may be treated with a metal salt such as sodium salt, or more specifically sodium nitrate or sodium chloride.

For better fusing to the PVC substrate 110, the surface of the first side 28 of the backing layer (which corresponds to a surface of the sheet of paper web 26) is composed of coarse fibres, which allow for sufficient negative spaces or grooves (on a microscopic level) for melding with the melted PVC material in the PVC press.

The primer layer 30 generally consists of a waterless ultraviolet (UV) cured offset primer that is rolled onto the second side 29 of the backing layer 20, in a substantially even layer. Prior to being applied to the backing layer 20 and cured, the primer layer 30 consists of a high density, low viscosity liquid. Once applied and UV cured, it is estimated that the thickness T_{P} of the primer layer 30, as a layer in the no-bake label 10, is less than about 0.010 mm, preferably in the range of about 0.003 to 0.008 mm, which is akin to a surface density of less than about 7.0 g/m², preferably in the range of about 4.0 to 5.0 g/m².

Referring now to FIG. 3, the primer layer 30 is illustrated as including a first or rearward facing side 32, and a second or forward facing side 34. The first side 32 is depicted as being in juxtaposed contact with the second side 29 of the backing layer 20. The second side 34 of the primer layer 30 may also be referred to as the “printing side”, as it is the surface upon which inks may ultimately be applied to the no-bake label 10. As described above, the no-bake label 10 may include a printed indicia layer 50 that identifies artist and/or song information relating to the PVC record to which the no-bake label 10 is to be fused. The printed indicia layer 50 may also, for example, include artwork(s) or other aesthetically pleasing drawings or representations.

In a most preferred embodiment of the invention, following primer layer 30 curing, the printed indicia layer 50 is applied as a substantially waterless ink layer. The ink used to form the printed indicia layer 50 also contains a water, humidity and/or moisture content of less than about 5%, preferably less than about 2%, more preferably less than about 1% by weight. The essentially “water-free” condition of the printed indicia layer 50 may at least be partially due to the type(s) of inks used to apply the printed indicia layer 50 to the second or “printing” side 34 of the primer layer 30. Preferably, the printed indicia layer 50 is composed of waterless inks applied using waterless printing by an offset lithographic printing process that eliminates the use of water or dampening solutions and/or systems employed by conventional water-based printing technology. Waterless offset inks generally have a higher tack and viscosity and are generally stiffer than conventional offset inks.

The main function of the primer layer 30 is to improve the receptivity of the surface of the backing layer 20 to accept waterless UV inks. Waterless inking generally eliminates the water or dampening systems which is used in conventional record label printing. Instead, waterless printing systems use silicone rubber coated printing plates in the printing process. Waterless inks are formulated especially not to adhere to the silicone non-image areas of waterless plates. Plastics and laminated paper products have surface energies that behave similarly to the silicone on waterless plates, and therefore will not accept waterless inks properly. A low viscosity offset primer based on a waterless UV curing system is therefore used as the primer layer 30 to improve the poor waterless ink receptivity of the surface of the second side 29, so as to promote the adherence of waterless inks to the backing layer 20.

The primer of the primer layer 30 may optionally be procured as part of a two-part UV curing system, including a waterless UV primer together with waterless UV inks. Such a system may, for example, include the Classicure Universal Primer MV10220™ and the Saraha Classicure™ or Nevada Classicure™ inks available from Classic Colours Ltd. (in the United Kingdom). The Sahara Classicure™ or Nevada Classicure™ inks, in particular, are available in cyan, magenta, yellow and black formulations (in accordance with standard CMYK or “cyan, magenta, yellow and key” printing practice).

In addition to improving chemical receptivity of the backing layer 20 to waterless inks, the primer layer 30 may also provide added smoothness to the backing layer 20, which improves the physical receptivity of the backing layer 20 to the inks. Depending upon the backing layer 20 used, the second side 29 may have a roughened surface that, on its own, is not physically conducive to the adherence or acceptance of waterless ink printing. Any microscopic imperfections or “roughness” in the printing surface of the second side 29 may hinder the adherence of waterless inks. Thus, the primer of the primer layer 30, when rolled unto the second side 29 of the backing layer 20, provides a more “even” or smooth surface upon which to apply waterless inks, resulting in the second or “printing” side 34 of the primer layer 30.

It is estimated that the thickness of the waterless inks, once printed to the surface of the second side 34 of the primer layer 30, provide a printed indicia layer 50 having a thickness that is less than about 0.0075 mm, preferably between about 0.002 and 0.005 mm, which equates to a surface density of less than about 5.0 g/m², preferably in the range of about 2.0 to 3.5 g/m².

The protective coating layer 40 of the no-bake label 10 consists of a heat resistant UV curable plastic topcoat that is typically clear in colour. A transparent protective coating layer 40 is generally used so that the printed indicia layer 50 remains visible therethrough. Prior to its application and curing, the protective coating 40 is typically a liquid, which is thereafter rolled in a substantially even layer onto the second side 34 of the primer layer 30, and over the printed indicia layer 50.

The thickness T_{T} of the protective coating layer 40, once applied and UV cured, is less than about 0.010 mm, preferably in the range of about 0.003 to 0.008 mm, which is akin to a surface density of less than about 7.0 g/m², and preferably in the range of about 4.0 to 5.0 g/m².

Like the sheets of paper web 24, 26 and the polymeric film 22, the protective coating layer 40 is characterized by thermal properties selected to resist high temperatures of between about 100° C. and 300° C., and preferably between about 120° C. and 150° C. In particular, the protective coating layer 40 is provided to protect the printed indicia layer 50 from heat exposure in the vinyl record pressing process; and to protect the surface of the second side 29 of the backing layer 20 and the printed indicia layer 50 from “bubbling” at high temperatures of contact with the metal stamper plates between about 100° C. and 300° C., and preferably between about 120° C. and 150° C., for between about 2 and 60 seconds, preferably between about 10 and 20 seconds.

The protective coating layer 40 preferably has a thickness T_{T} and thermal resistivity and/or reflectivity selected to assist in maintaining the sheet of paper web 24 and printed indicia layer 50 beneath a “bubbling” temperature at contact with the metal plates of the PVC press of between about 100° C. and 300° C., and preferably between about 120° C. and 150° C., for between about 2 and 60 seconds, preferably between about 10 and 20 seconds. As described above, a contact “bubbling” temperature of the sheet of paper web 24 and/or printed indicia layer 50 occurs where heating of the backing layer 20 causes unwanted wrinkling in the no-bake label 10 and/or heat damage and/or “lifting” of the printed indicia layer 50 from the no-bake label 10. While protecting the printed indicia layer 50 and the backing layer 20 from “bubbling”, the thickness of the protective coating layer 40 permits sufficient heat transfer to the first side 28 of the backing layer 20, so as to enable heat fusing of the label 10 to the PVC substrate 110 during melt press operations.

Additionally, the protective coating 40 is generally selected from a material that assists in preventing adherence or “sticking” of the no-bake label 10 to the metal plates of the PVC press, which are typically constructed of silver, nickel or silver-nickel blended metals.

A suitable protective coating 40 is available from ACTEGA™ North America, Inc. under the product name Super Gloss SR OPV™.

### Method of Manufacture

The no-bake label 10 according to the present invention may be assembled or fabricated on a continuous line. It is preferable that waterless presses and/or machinery are used throughout the manufacturing process, so as to further eliminate any chance of humidity accumulating in the label prior to its fusing to the PVC record. Suitable waterless presses and machinery are selected having components and materials that repel water. In this way, the waterless machinery may advantageously prevent the unwanted introduction of water or humidity into a manufacturing line.

As discussed previously, various thicknesses T_{S} of the backing layer 20 may be used, however, preferably the thickness T_{S} is selected at between about 0.10 and 0.15 mm. It is recognized that this thickness T_{S} allows for reliable feeding into a press or roller machine, thus avoiding difficulties in machinery pick-up where the backing layer 20 is too thin; and in unwanted and costly paper jams resulting from a backing layer 20 that is too thick.

Following the feeding of the backing layer 20 to the waterless press, the primer layer 30 is applied to the backing layer 20 via an analog roller printer. An 11 BCM (Billion Cubic Microns) roller has been found to be effective in applying the primer layer 30. The backing layer 20 may be primed (with the primer of the primer layer 30) either in-line with UV lamp curing, or pre-primed prior to printing. UV curing of the primer layer 30 may generally be completed in less than about 2 seconds, and preferably within about 0.2 to 1.5 seconds.

Once the primer layer 30 is applied and cured, the second side 34 of the primer layer 30 is ready to receive waterless ink prints in the format of the printed indicia layer 50. In forming the printed indicia layer 50, the waterless UV inks may be applied using 7.5 BCM rollers via standard inking methods.

Following printing, the protective coating layer 40 is applied, also in a roll-on application, over the primer layer 30 and the printed indicia layer 50. An 11 BCM roller has been found to be effective in applying the protective coating layer 40. UV curing of the protective coating layer 40 may typically be completed in less than about 2 seconds, and preferably within about 0.2 to 1.5 seconds.

Following the application and curing of the protective coating layer 40, the resulting sheet typically has a thickness of between about 0.20 and 0.50 mm, preferably between about 0.35 and 0.45 mm, which is comparable to paper stock having a weight of between about 60 and 120 lbs, preferably about 80 and 100 lbs (per 500 sheets).

The label 10 may then be cut from the resulting sheet using a punch press or other suitable methods. Generally, the final label 10 will be circular in shape, and have standard industry dimensions. A label destined for a 10-inch record, for example, typically has a diameter in the range of about 3⅝ to 4 inches. Similarly, a label that is destined for a 12-inch record typically has a diameter in the range of about 4 to 4⅛ inches. And a label that is destined for a 7-inch record typically has a diameter in the range of about 3⅝ to 4 inches.

Preferably, when not used immediately, the final label 10 is to be stored in a low humidity environment to await thermal fusing via PVC pressing operations. As discussed previously, in order to avoid unwanted accumulation of humidity or moisture in the no-bake label 10, storage spaces should be climate controlled so as to maintain a humidity level of less than about 35%, preferably less than about 30%.

### Fusing of the No-Bake Label to PVC Records

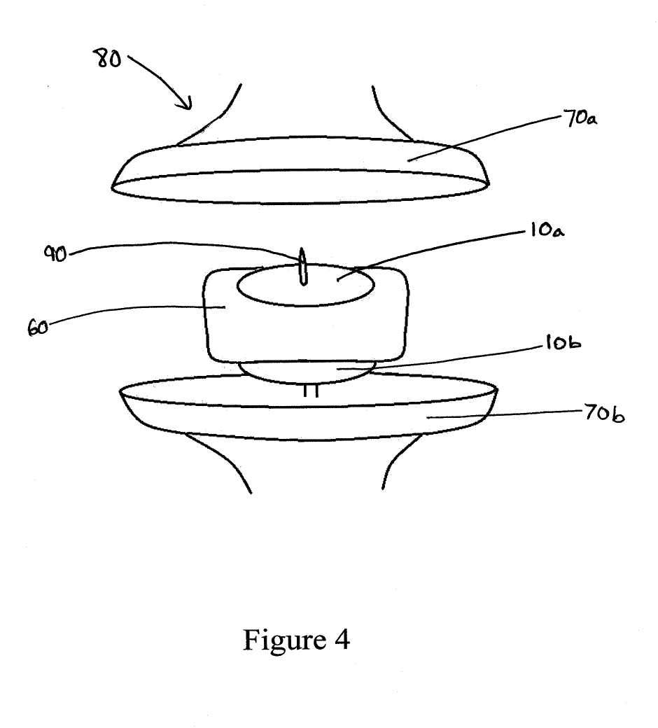

The method of fusing a no-bake label 10 according to the present invention to a PVC record or substrate 110 in a PVC press 80 is described with reference to FIGS. 4 to 6.

Firstly, small pellets of PVC (not shown) are fed through a hopper (not shown) and into a heat extruder (not shown), which heats the pellets to about 300 degrees C. The PVC material exits the extruder and is cut or formed into thick disc-like cylinders, which are termed “pucks” or “biscuits”. PVC pellets and the resulting PVC puck 60 are typically black in colour, but may also take on a variety of different colours, including clear. For 12-inch record manufacturing, the PVC puck 60 generally has a weight between about 140 g and 200 g; a radial diameter of between about 3.0 and 5.0 inches, preferably between about 3.5 and 4.2 inches; and an axial thickness that is less than about 2.0 inches, preferably between about 0.8 and 1.5 inches. A single PVC puck 60, as may be seen in FIG. 4, is ultimately used in the pressing of a single PVC or vinyl record 110.

Prior to record pressing, information from an audio file is cut into a lacquer that is used to produce a pair of metal stampers or moulds 70a, 70b. The stampers 70a, 70b contain grooves having all of the necessary audio information for producing the vinyl record 110. These stampers or moulds 70a, 70b are typically constructed of metal, including but not limited to silver and/or nickel. The stampers 70a, 70b are provided so as to be moveable in relation to one another as part of the PVC press 80 (shown in FIG. 4).

As may be seen from FIG. 4, a no-bake label 10a according to the present invention is placed on top of the PVC puck 60, which is provided between the two stampers 70a, 70b. Typically, a second no-bake label 10b is also included (though not in all cases) below the PVC puck 60. A pin 90 is insertable through axially aligned openings fused through each of the no-bake labels 10a, 10b and the PVC puck 60, and is generally used to hold all of the individual pieces together in vertical alignment during molding.

Contrary to current industry standard practice, the no-bake labels 10a, 10b are positioned directly between the stampers 70a, 70b without pre-heating or “pre-baking” prior to being pressed in the PVC press 80. In situations where, prior to pressing operations, the no-bake labels 10a, 10b have been exposed to a high humidity environment, they may optionally be dried for a shortened period of time of less than 5 minutes, at temperatures in the range of about 50 to 200 degrees C., preferably about 160 degrees C., in order to eliminate any absorbed moisture in the labels 10a, 10b which may have resulted from exposure to humidity in the air.

The PVC press 80, such as the automated Warm Tone Record Press™ designed by Viryl Technologies Corp., is subsequently used to heat and press the stampers 70a, 70b together, thereby melting and squishing the PVC puck 60 to fill and conform to their respective moulds 70a, 70b. The compression pressure used in the PVC press 80 is typically in the range of about 100 to 200 tons, preferably about 150 tons; and the heat provided by the press 80 is typically in the range of about 100 and 200 degrees C., preferably about 120 to 150 degrees C. The stampers 70a, 70b are generally heated by way of steam over a period of between about 10 and 100 seconds, depending upon the press 80 used. Once heated, the PVC puck 60 is pressed between the heated stampers 70a, 70b for a period of less than about 60 seconds, preferably in the range of about 10 to 20 seconds.

The heat and pressure provided by the PVC press 80 furthermore causes the fusing of the no-bake labels 10a, 10b to the PVC material.

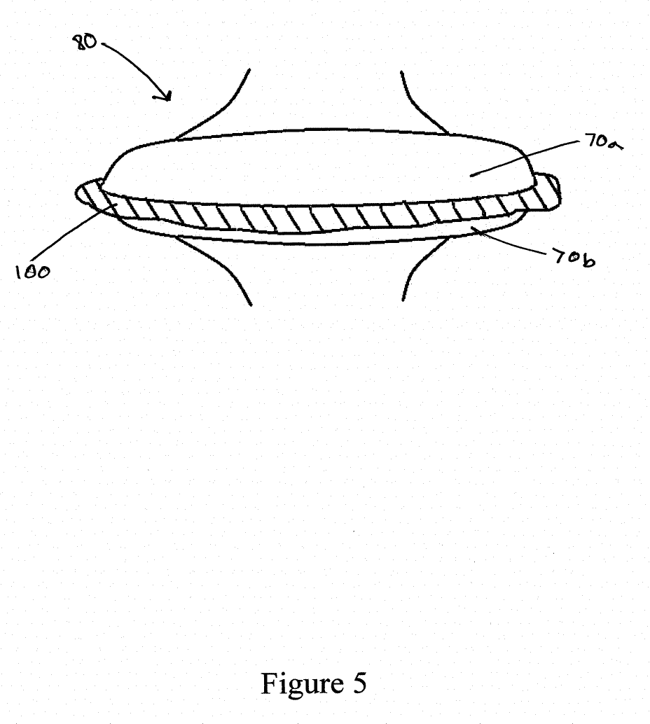

Any excess PVC (depicted in FIG. 5 by reference numeral 100) protruding from the stampers 70a, 70b is cut away or trimmed from the edges of the stampers 70a, 70b prior to releasing the stampers 70a, 70b. Once this is done, the resulting PVC record 110 (shown in FIG. 6) having fused thereon the labels 10a, 10b may be removed from the press 80 and moved to a chilling station (not shown). Chilling water may be used to ease the separation of the PVC record 110 from the stampers 70a, 70b.

With proper automated equipment, all of the above process steps for pressing a vinyl record 110 and simultaneously fusing no-bake labels 10a, 10b to either sides can be accomplished in under 1 minute, preferably in less than 30 seconds.

The completed LP (or “long play”) record 120, shown in FIG. 6, includes both the vinyl or PVC record 110 and the labels 10a, 10b which are fused thereto.

Although the Figures depict the no-bake label 10 as including a backing layer 20 consisting of a polymeric film 22 sandwiched in between two sheets of paper web 24, 26, the invention is not so limited. It should be appreciated that the backing layer 20 may also alternatively comprise a single sheet of paper web coated with a polymeric film, or two sheets of paper web alternating with polymeric films, etc. A person skilled in the art would accordingly recognize a variety of different configurations for backing layers suitable for use in the present invention.

Although the description describes the two sheets of paper web 24, 26 of the backing layer 20 as being made from softwood kraft, hardwood kraft and/or recycled fiber, the invention is not so limited. It should be appreciated that other types of paper webs may be used in the backing layer 20 without departing from the scope of the invention. The person skilled in the art would, for example, readily recognize a variety of synthetic papers, cotton papers, linen papers, and/or linen-cotton blended papers which may be suitable for use as paper webs in the backing layer 20.

It should furthermore be appreciated that the backing layer 20 may be varied according to the application, and does not necessarily need to be procured from the PaperTyger® brand of laminated solvent-free paper products. Any paper/plastic laminate sheet possessing the requisite water resistivity and thermal characteristics, as well as any other characteristics required of the particular PVC pressing operation (as may be appreciated by a person skilled in the relevant art), may alternatively be used without departing from the scope of the invention.

Although the description describes the primer of the primer layer 30 as being procurable from Classic Colours Ltd. as part of a two-part waterless UV curing system, the invention is not so limited. It should be appreciated that other alternative primers, inks and/or primer/ink sets suitable for use with a particular PVC record label press may also be used without departing from the scope of the invention. Although the invention describes the preferred embodiment as including UV curable components (i.e. primer, inks, and topcoat), it should be appreciated that the invention is not limited to UV curing systems, and that other priming, inking and finishing methods standard to the relevant industry may also be used without departing from the scope of the invention.

Although the Figures depict the no-bake label 10 as including a protective coating layer 40, the invention is not so limited. It should be appreciated that the no-bake label may optionally be manufactured and thermally fused to a PVC record 110 without a protective coating layer. Furthermore, it should be appreciated that the optional protective coating layer 40 may be included in the no-bake label 10 in any of a variety of different colours, and is not limited to clear or other transparent or translucent tints.

Although the description describes the protective coating 40 as being obtainable from ACTEGA™ North America, Inc. under the product name Super Gloss SR OPV™, the invention is not so limited. The person skilled in the art will recognize that a number of alternative topcoats available in the marketplace may also be used to protect the printed indicia layer 50 and the backing layer 20 from extreme heat in the PVC pressing process, without departing from the scope of the invention.

Although the description describes the primer layer 30, the waterless inks and the protective coating layer 40 as being applied in succession by 11 BCM rollers, 7.5 BCM rollers and 11 BCM rollers, respectively, the invention is not so limited. It should be appreciated that different sized rollers may be used depending upon the particular application, without departing from the scope of the invention.

Although the detailed description describes the no-bake label 10, and no-bake labels 10a, 10b, as being heat fusible to a PVC record or substrate 110, the invention is not so limited. It should be appreciated that the no-bake label of the present invention may also be suitable for heat fusing or bonding to a variety of different substrates, including but not limited to products composed of one or more plastics, such as polyethylene terephthalate (PET or PETE or polyester), high density polyethylene (HDPE), low density polyethylene (LDPE), polypropylene (PP), or polystyrene (PS).

The foregoing descriptions of specific embodiments have been presented for the purposes of illustration and description. They are not intended to be exhaustive or to limit the invention and method of use to the precise forms disclosed. The various modifications and variations can be appreciated by one skilled in the art in light of the above teachings. The embodiments have been chosen and described in order to best explain the principles and practical application in accordance with the invention in order to enable those skilled in the art to best utilize the various embodiments with expected modifications as are suited to the particular use contemplated. It is understood that various omissions or substitutions of equivalence are contemplated as circumstance may suggest or render expedient, but is intended to cover the application or implantation without departing from the scope of the invention.

### DESCRIPTIVE KEY

10, 10a, 10b No-bake label
20 Laminate paper substrate or backing layer
22 Polymeric film
24, 26 Layers or sheets of paper web
28 First or rearward facing side of the laminate paper backing layer
29 Second or forward facing side of the laminate paper backing layer
30 Bonding agent or primer layer
32 First or rearward facing side of the primer layer
34 Second or forward facing side of the primer layer (the “printing” side)
40 Topcoat or protective coating layer
50 Printed indicia layer
60 PVC puck
70a, 70b Stampers or moulds
80 PVC press
90 Pin
100 Excess PVC material protruding from PVC press
110 Plastic or PVC or vinyl record/substrate
120 Completed LP (or “long play”) record
T_{S} Thickness of the laminate paper backing layer
T_{P} Thickness of the primer layer
T_{T} Thickness of the protective coating layer

1. A heat bondable label for thermal fusing with a plastic substrate, the label comprising:
a substantially waterless laminate paper backing layer comprising first and second paper web layers, and a polymeric film interposed and bonded between the first and second paper web layers, each paper web layer selected from the group consisting of softwood kraft papers, hardwood kraft papers, recycled fiber papers, synthetic papers, cotton papers, linen papers and cotton and linen fiber blended papers, the laminate paper backing layer having a forward and rearward facing side, the forward facing side corresponding to a side of the first paper web layer;
a primer layer in juxtaposed contact with the forward facing side, the primer layer comprising a UV curable catalyst; and
a substantially waterless printed indicia layer disposed over at least a portion of the primer layer.

2. A heat bondable label for thermal fusing with a plastic substrate, the label comprising:
a substantially waterless laminate paper backing layer comprising a paper web layer and a polymeric film bonded to the paper web layer, the paper web layer selected from the group consisting of softwood kraft papers, hardwood kraft papers, recycled fiber papers, synthetic papers, cotton papers, linen papers and cotton and linen fiber blended papers, the laminate paper backing layer having a forward and rearward facing side, the forward facing side corresponding to a side of the paper web layer;
a primer layer in juxtaposed contact with the forward facing side, the primer layer comprising a UV curable catalyst; and
a substantially waterless printed indicia layer disposed over at least a portion of the primer layer.

3. The heat bondable label of claim 1, further comprising a UV thermally insulated protective coating covering the printed indicia layer and the primer layer, wherein the protective coating has a thickness and thermal resistivity and/or reflectivity selected to maintain the printed indicia layer and the first paper web layer below a contact bubbling temperature of between 100° C. and 300° C., and preferably between 120° C. and 150° C., for between 2 and 60 seconds, preferably 10 and 20 seconds.

4. The heat bondable label of claim 3, wherein the polymeric film has a thermal resistivity selected to maintain dimensional stability and prevent shrinkage and distortion of the polymeric film at temperatures of between 100° C. and 300° C., and preferably between 120° C. and 150° C., for between 2 and 60 seconds, preferably 10 and 20 seconds.

5. The heat bondable label of claim 3, wherein the first and second paper web layers have a thermal resistivity selected to maintain dimensional stability of the first and second paper web layers at temperatures of between 100° C. and 300° C., and preferably between 120° C. and 150° C., for between 2 and 60 seconds, preferably 10 and 20 seconds.

6. The heat bondable label of claim 1, wherein the polymeric film comprises a biodegradable polymer selected from the group consisting of polyethylene, high density polyethylene, low density polyethylene, polyester, polyethylene terephthalate, monoaxially oriented polypropylene and biaxially oriented polypropylene.

7. The heat bondable label of claim 1, wherein the plastic substrate is a polyvinyl chloride record.

8. The heat bondable label of claim 1, wherein the first and second paper web layers are substantially starch-free.

9. The heat bondable label of claim 1, wherein the heat bondable label is a center disk record label which is provided without a pre-heating treatment for moisture removal.

10. A record having fused thereto the heat bondable label of claim 1, and wherein the heat bondable label is not subjected to a pre-baking treatment for moisture removal.

11. A heat bonded label in combination with a polyvinyl chloride record, wherein the label comprises:
a substantially waterless laminate paper backing layer comprising first and second paper web layers, and a polymeric film interposed and bonded between the first and second paper web layers, each paper web layer selected from the group consisting of softwood kraft papers, hardwood kraft papers, recycled fiber papers, synthetic papers, cotton papers, linen papers and cotton and linen fiber blended papers, the laminate paper backing layer having a forward and rearward facing side, the forward facing side corresponding to a side of the first paper web layer;
a primer layer in juxtaposed contact with the forward facing side, the primer layer comprising a UV curable catalyst;
a printed indicia layer disposed over at least a portion of the primer layer; and
a UV thermally insulated protective coating covering the printed indicia layer and the primer layer, wherein the protective coating has a thickness and thermal resistivity and/or reflectivity selected to maintain the printed indicia layer and the first paper web layer below a contact bubbling temperature of between 100° C. and 300° C., and preferably between 120° C. and 150° C., for between 2 and 60 seconds, preferably 10 and 20 seconds.

12. The combination of claim 11, wherein the polymeric film comprises a biodegradable polymer selected from the group consisting of polyethylene, high density polyethylene, low density polyethylene, polyester, polyethylene terephthalate, monoaxially oriented polypropylene and biaxially oriented polypropylene.

13. The combination of claim 11, wherein the heat bonded label is a center disk record label which is provided without a pre-heating treatment for moisture removal.

14. The combination of claim 11, wherein the first and second paper web layers are substantially starch-free.

15. A method of fusing at least one heat bondable label according to claim 1 to a plastic substrate, comprising the steps of:
placing the at least one bondable label, together with the plastic substrate, in a press comprising a pair of metal stampers or moulds; and
pressing the at least one bondable label and the plastic substrate between the stampers or moulds at a temperature in the range of 100° C. and 200° C., preferably in the range of 120° C. and 150° C., and at a pressure in the range of 100 to 200 tons, preferably about 150 tons, for a period of between 2 and 60 seconds, preferably between 10 and 20 seconds.

16. The method of claim 15, wherein the plastic substrate comprises polyvinyl chloride.

17. The method of claim 15, wherein the plastic substrate is a polyvinyl chloride puck.

18. The method of claim 15, wherein the metal stampers or moulds comprise grooves that represent audio or music information for imprinting into the plastic substrate.

19. The method of claim 15, wherein each step is substantially waterless.

20. The heat bondable label of claim 2, wherein the heat bondable label is a no-bake label.
